(19) United States
(12) Patent Application Publication
(10) Pub. No.: US 2007/0054188 A1
(43) Pub. Date: Mar. 8, 2007

(54) High-temperature electrochemical cell and battery

(76) Inventors: Melvin N. Miller, Wynnewood, PA (US); James R. Akridge, Tucson, AZ (US); Yuriy Mikhaylik, Tucson, AZ (US)

Correspondence Address: Squire, Sanders & Dempsey L.L.P.;Two Renaissance Squire, 40 North Central Avenue, Suite 2700, Phoenix, AZ, 85004-4498, US

(21) Appl. No.: 11/221,575

(22) Filed: Sep. 7, 2005

(51) Int. Cl. H01M 4/58; H01M 2/16; H01M 2/02

(52) U.S. Cl. 429/218.1; 429/252; 429/176

(57) ABSTRACT

A high-temperature electrochemical cell for use in applications such as downhole drilling comprises an anode, cathode and an electrolyte. The anode preferably includes either stabilized lithium/silicon intermetallic and/or lithium-tin/aluminum anode on a nickel-plated, copper substrate. The cathode contains sulfur and the electrolyte includes at least a high-boiling point glyme and lithium salt. The separator comprises one or more metal oxides with a polymer matrix, and is preferably flexible. A battery including one or more of the electrochemical cells has a high-temperature casing such as stainless steel.

### FIELD OF THE INVENTION

The invention relates to electrochemical cells and batteries that may be used in high-temperature applications, such as downhole mining or drilling. The electrochemical cell is preferably secondary (or rechargeable) and most preferably comprises lithium-sulfur chemistry suitable for high-temperature applications.

### BACKGROUND OF THE INVENTION

Control systems for oil wells, geothermal wells and other high-temperature applications use devices and circuits that require electrical power. Presently known methods of supplying or generating electricity in these high-temperature applications, such as downhole applications, suffer from a host of problems and deficiencies. In particular, present batteries used in these applications are primary (or non-rechargeable) and have a relatively short life in these high temperatures environments. The batteries must therefore be replaced when exhausted, and replacing a battery used in an application such as a downhole environment is difficult, time-consuming, and expensive.

One manner of providing electricity downhole in a well includes lowering a tool on a wireline and conducting electricity from the surface, through the wire line to the tool positioned downhole. This technique is not always desirable because it is relatively complex; it requires the wireline to be passed through wellhead closure equipment at the mouth of the well, creating safety problems. Furthermore, at least in deep wells, there can be significant energy loss caused by the resistance or impedance of a long wire line.

Another manner of providing electricity downhole utilizes one or more batteries housed in the downhole assembly. For example, lithium-thionyl-chloride batteries have been used with downhole tools. A shortcoming of such batteries, however, is that they cannot provide moderate (or higher) amounts of electrical energy (e.g. 30 kilowatt-hours) at elevated temperatures, such as those encountered in petroleum and geothermal wells. Still another problem with such batteries is their relatively short operating life, requiring that the batteries be replaced and/or recharged often, an expensive endeavor, especially if the battery is in a location that is difficult to access, such as in a petroleum well.

Because of the shortcomings of supplying power by either wireline or battery sources, suggestions have been made to provide a downhole mechanism that continuously generates and supplies electricity. For example, U.S. Pat. No. 4,805,407 to Buchanan discloses a downhole electrical generator/power supply that includes a housing in which a primary fuel source (which is a Stirling cycle engine) and a linear alternator are disposed. The primary fuel source includes a radioisotope that, by its radioactive decay, provides heat to operate the Stirling engine, which in turn drives the linear alternator to provide a suitable electrical output for use by the circuit of the downhole tool.

U.S. Pat. No. 5,202,194 to VanBerg Jr. discloses a downhole power supply comprised of a fuel cell.

U.S. Pat. Nos. 3,970,877 to Russell et al. ('877 patent) and 4,518,888 to Zabcik ('888 patent) both relate to the use of piezoelectric techniques for generating small electric currents. The '888 patent discloses a method of generating electrical energy downhole (in the drillstring) by the use of a piezoelectric device stored in the drill collar that converts vibrational energy from the drillstring into electrical energy. The piezoelectric device is in the form of a stack of piezoelectric elements arranged in an electrically additive configuration. The '877 patent describes a method of power generation used in a drilling operation wherein a piezoelectric material is responsive to turbulence in the mud flowing past the piezoelectric material. The vibrations resulting from the turbulent flow of the mud past the piezoelectric material is converted into an electrical output. In addition to a piezoelectric material, the '877 patent also discloses the use of a fixed coil with a freely movable magnetic core that is attached to the inner surface of a flexible disk that will also be actuated by the flowing mud for generation of electrical energy.

With the above-described problems for supplying power for downhole drilling applications, there has been considerable interest in recent years in developing high energy-density batteries with lithium-containing anodes. Lithium metal is particularly attractive as the anode active material of an electrochemical cell because of its light weight and high energy density, as compared, for example, to anode active materials such as lithium intercalated carbon anodes, wherein the presence of non-electroactive materials increases the weight and volume of the anode, thereby reducing its energy density. The use of lithium metal anodes, or anodes comprising lithium metal provides an opportunity to construct cells that are lighter in weight and have a higher energy density than cells utilizing lithium-ion, nickel metal hydride or nickel-cadmium anodes. These features are highly desirable for virtually all batteries, including those used in portable electronic devices such as cellular telephones and laptop computers, as noted, for example, by Linden in Handbook of Batteries, 1995, 2^{nd} Edition, chapter 14, pp. 75-76, and chapter 36, p. 2, McGraw-Hill, New York, and in U.S. Pat. No. 6,406,815 to Sandberg et al., the respective disclosures of which are incorporated herein by reference.

U.S. Pat. No. 5,839,508 to Tubel et al. describes a downhole electrical generating apparatus that connects to the production tubing, and through which production fluid flows to generate power. A generator may be used to charge a rechargeable battery located near the generator. The battery provides power when the flow of production fluids is halted or slowed. The rechargeable battery used is described as a lithium cell with a polymer electrolyte or a nickel-cadmium cell having the ability to operate at high temperatures.

U.S. Pat. No. 6,187,469 to Marincic et al. describes a solid state, jelly roll wound, hollow, cylindrical battery for high temperature applications, such as downhole applications. The cell is described as having a lithium anode; a VOₓ based cathode and a solid polymer electrolyte, and can be operated even at temperatures up to about 125° C. Cells with liquid or gel electrolyte for high temperature operations are described as not being currently available, and requiring a sufficient cooling device, that is not possible or economical (Col. 1, lines 36-41).

Thin film battery design is known for portale electronic devices, and offers a number of advantages. Thin film designs because of the resulting light weight of the cell components combined with high surface area electrodes allow high rate capability, as well as reduced current density on charging and/or shorter charge time. Thin film battery designs are generally defined as those in which the electrodes employed have a thickness of 500 microns or less and are comprised of multiple layers and/or coatings. Several types of cathode active materials for thin-film lithium batteries are known, and include sulfur-containing cathode materials comprising sulfur-sulfur bonds, wherein high energy capacity and rechargeability are achieved from the electrochemical cleavage (via reduction) and reformation (via oxidation) of sulfur-sulfur bonds. Examples of sulfur containing cathode materials for use in electrochemical cells having lithium or sodium anodes include elemental sulfur, organo-sulfur polymer and other organo-sulfur compositions, or carbon-sulfur compositions.

Lithium anodes in nonaqueous electrochemical cells develop surface films from reaction with cell components, including nonaqueous solvents of the electrolyte system and materials dissolved in the solvents, such as, for example, electrolyte salts and materials that enter the electrolyte from the cathode. Materials entering the electrolyte from the cathode may include components of the cathode formulations and reduction products of the cathode formed upon cell discharge. In electrochemical cells with cathodes comprising sulfur-containing materials reduction products may include sulfides and polysulfides. The composition and properties of surface films on lithium electrodes have been extensively studied, and some of these studies have been summarized by Aurbach in Nonaqueous Electrochemistry, Chapter 6, pages 289-366, Marcel Dekker, New York, 1999. The surface films have been termed solid electrolyte interface (SEI) by Peled, in J. Electrochem. Soc., 1979, vol. 126, pages 2047-2051.

Among the examples of nonaqueous electrolyte solvents for lithium batteries described by Dominey in Lithium Batteries, New Materials, Developments and Perspectives, Chapter 4, pp. 137-165, Elsevier, Amsterdam (1994) are dioxolanes and glymes. Members of the glyme family, including dimethoxyethane (DME), diglyme (diethylene glycol dimethyl ether), triglyme (triethylene glycol dimethyl ether), ethylene glycol diethyl ether (DEE), and diethylene glycol diethyl ether, are often listed as being suitable liquid electrolyte solvents, for example in U.S. Pat. No. 6,051,343 to Suzuki et al., U.S. Pat. No. 6,019,908 to Kono et al., and U.S. Pat. No. 5,856,039 to Takahashi. Electrolyte solvents comprising dioxolane and glymes have been described for use in nonaqueous liquid electrochemical cells with a variety of anodes and cathodes. For example, in U.S. Pat. Nos. 4,084,045 to Kegelman, 4,086,403 to Whittingham et al., 3,877,983 to Hovsepian, and 6,218,054 to Webber, dioxolane and dimethoxyethane (DME) comprise the electrolyte solvents. Nimon et al. in U.S. Pat. No. 6,225,002 describes battery cells with gel or solid state electrolytes that comprise glymes and less than 30% by volume of dioxolane.

For rechargeable lithium/sulfur (Li/S) cells, there is a need for further enhancement of cell performance, for example through improvements in the electrolyte solvent system. Ideally, cells should have high utilization at practical discharge rates over many cycles. Complete discharge of a cell over times ranging from 20 minutes (3C) to 3 hours (C/3) is typically considered a practical discharge rate. Cycle life is typically considered the number of cycles to the point when a cell is no longer able to maintain acceptable levels of charge capacity, such as 80% of the initial capacity of the battery. Rechargeable cell chemistries may also be used in primary cells. As used herein, a primary cell is a cell that after the first discharge during use is not subject to further charge/discharge cycles. As for rechargeable cells, there exists a need for further enhancement of cell performance of primary cells.

As used herein, a “100% utilization” (also called “sulfur utilization”) assumes that if all elemental sulfur in an electrode is fully used, the electrode will produce 1675 mAh per gram of sulfur initially present in the electrode. Among the prior art references that discuss and teach performance in Li/S cells, including parameters such as sulfur utilization, discharge rates, and cycle life are the following: (1) Peled et al. in J. Electrochem. Soc., 1989, vol. 136, pp. 1621-1625 found that in dioxolane solvent mixtures Li/S cells achieve a sulfur utilization of no more than 50% at discharge rates of 0.1 mA/cm² and 0.01 mA/cm²; (2) Chu in U.S. Pat. No. 5,686,201 describes a Li/S cell with a polymeric electrolyte separator that delivers 54% utilization at 30° C. and a low discharge rate of 0.02 mA/cm² for the first discharge. At 80° C. a utilization of 90% at a discharge rate of 0.1 mA/cm² was achieved for the first discharge; (3) Chu et al. in U.S. Pat. No. 6,030,720 describe liquid electrolyte Li/S rechargeable cells with sulfur utilization of approximately 40% for more than 70 cycles at discharge rates of 0.09 mA/cm² (90 μA/cm²) and 0.5 mA/cm² (500 μA/cm²) at 25° C. In another example (example 4) Chu et al. describes a sulfur utilization of 60% over more than 35 cycles at 25° C. but at the low discharge rate of 0.09 mA/cm²; (4) Mukherjee et al. in U.S. Pat. No. 5,919,587 describe liquid electrolyte Li/S rechargeable cells with sulfur utilization of approximately 36% for more than 60 cycles at discharge rates of 0.57 mA/cm² at ambient temperature; (5) Zhang et al. in U.S. Pat. No. 6,110,619 describe liquid electrolyte Li/S rechargeable cells with sulfur utilization of approximately 38% for more than 100 cycles and 19% for more than 200 cycles at discharge rates of 0.33 mA/cm² at ambient temperature; (6) Cheng in U.S. Pat. No. 6,544,688 describes liquid electrolyte Li/S rechargeable cells with sulfur utilization of approximately 45% for more than 100 cycles at discharge rates of 0.42 mA/cm² at ambient/room temperature; and (7) Geronov in U.S. Pat. No. 6,344,293 describes liquid electrolyte Li/S rechargeable cells with a sulfur utilization of approximately 21% after more than 275 cycles at discharge rates of 0.41 mA/cm² at ambient temperature.

Among the prior art references that discuss and teach the effect of different glycol ethers in electrolytes on the performance of lithium cells are the following: (1) Nishio et al. in J. Power Sources, 1995, vol. 55, pp. 115-117, find that discharge capacities of MnO₂/Li cells in electrolyte solvent mixtures of propylene carbonate (PC) with ethers DME, ethoxymethoxyethane (EME), or DEE (1:1 volume ratio) show declining capacity in the order DME/PC>EME/PC>DEE/PC; and (2) in U.S. Pat. No. 5,272,022 to Takami et al. lithium ion batteries with a lithium cobalt oxide cathode are described in which the electrolyte solvents include carbonates mixed with the glymes DME, DEE, and EME. The cycle life of cells with electrolyte solvent mixtures of DME with diethyl carbonate and propylene carbonate is greater than the cycle life obtained with EME and these carbonates. In summary, in these head to head comparisons DME containing electrolyte solvent mixtures outperform the equivalent EME containing solvent mixtures.

In U.S. Pat. No. 4,804,595 to Bakos et al. it is reported that 1,2-dimethoxypropane provides comparable performance to DME in electrolyte formulations with propylene carbonate in electrochemical cells with lithium anodes and MnO₂ or FeSₛ cathodes.

Thus, there is a need for both primary and rechargeable electrochemical cells and batteries for use in high-temperature applications that have a long life and can generate relatively high amounts of power. It would be most preferred if such electrochemical cells and batteries were rechargeable.

### SUMMARY OF THE INVENTION

The present invention pertains to electrochemical cells and batteries for use in high-temperature environments. The cells of the present invention may be either primary or rechargeable cells. The cells of the present invention are preferably rechargeable. One embodiment of the invention is a rechargeable cell comprising a lithium-containing anode, and a sulfur-containing cathode that is capable of functioning at temperatures above 80° C. or higher, and most preferably between 90 and 200° C. Another cell according to the invention generally comprises: (a) an anode comprising lithium; (b) a cathode comprising an electroactive sulfur-containing material; and (c) a liquid nonaqueous electrolyte, wherein the electrolyte comprises: (i) one or more lithium salts; and (ii) a solvent mixture comprising one or more higher gylmes. In yet another embodiment of the invention the cell comprises a separator comprising one or more metal oxides. Preferably the separator also comprises a polymer matrix. The separator is preferably flexible.

Another cell according to the invention is rechargeable and at temperatures greater than 80° C., preferably greater than 90° C., and attains a utilization of 50-75% over 2-10 cycles.

A battery according to the invention may include one or more of any of the cells disclosed or claimed herein, and preferably has a casing suitable for a high-temperature environment. The casing is most preferably stainless steel. The casing may also comprise a blowout value or welded tabs. Preferably, the cells of the present invention operate without mechanical cooling.

The cells and batteries according to the invention show high sulfur utilization over many discharge-charge cycles at practical rates of discharge and charge.

The present invention also pertains to downhole monitoring devices or drilling systems comprising one or more of the cells or batteries of the present invention. Preferably the cells of the monitoring device are recharged downhole.

### DETAILED DESCRIPTION OF THE INVENTION

The terms “C/10”, “C/5”, or “C rate,” as used herein, describe the discharge or the charge current of a cell expressed in terms of the rated capacity of the cell. The “C rate” is described, for example, by Linden in Handbook of Batteries, 1995, 2^{nd} Edition, pp. 3.5-3.6, McGraw-Hill, New York.

The term “theoretical” discharge capacity of the electroactive sulfur-containing material, as used herein, describes the capacity from the breaking of sulfur-sulfur bonds. For example, for elemental sulfur the theoretical discharge capacity is 1675 mAh/g. The term “fully charged,” as used herein, relates to the electroactive sulfur-containing material of the cathode being uncharged. For example, where the electroactive material of the cathode is elemental sulfur the fully charged state is S⁻².

In some invention embodiments, the electrochemical cell consists of a cathode that incorporates an electroactive material suitable for use in harsh environments, such as those experienced downhole in a drilling well or experienced in outer space. In some cases the electroactive material is elemental S or a sulfur-containing material, such as a sulfur-polymer, or a chalcogenide-containing material. For purposes of this disclosure, harsh environments are environments that that require an electrochemical cell and/or battery to operate at temperatures between 80° C. and 200° C., and preferably between 90° C. and 200° C. The working locations in some such environments, including downhole applications, are difficult to access and making cell or battery replacement time consuming and expensive. The electrochemical cells and batteries of the present invention are designed to operate at these temperatures.

Cells and batteries that can function in such high-temperature environments include a combination of two or more of the following elements, with the functions, structures and/or chemistries described herein: cathodes, cathode materials, or cathode construction with increased ability to withstand elevated temperatures; anode, anode material or anode construction with increased ability to withstand elevated temperatures; electrolyte material increased ability to withstand high temperatures; separator, separator material or separator construction with increased ability to withstand elevated temperatures; and robust metal packaging capable of protecting the active components of the battery from the harsh environment encountered down hole. The cells and batteries of the present invention may be either primary or rechargeable (secondary) cells.

The inaccessibility challenges act at a practical level. For example, prior art batteries used for downhole environments were primary batteries, which usually have higher capacities than secondary batteries, but that cannot normally be recharged. Battery replacement of can take upwards of three days compared to these types of batteries typical life of about three days. Therefore, the inaccessibility of the batteries in downhole applications is suited for secondary cells and batteries that can be recharged in-situ thus avoiding delays caused by battery replacement. In addition to being rechargeable, electrochemical cells according to this invention are designed to meet the challenges of high-temperature environments, and include at least one of relatively high capacity, rechargeablility, or long cycle lifetime.

Batteries according to the invention include a container (casing) designed to resist the vibrations, heat, and pressure experienced in downhole applications. The casing is preferably constructed of corrosion-resistant metal (such as stainless steel). Preferably, the case comprises at least one of a blowout valve or welded tabs. In an alternative embodiment, the casing may comprise a glass to metal feed through. The glass is preferably corrosion resistant.

A variety of electrochemical cell chemistries and structures can be adapted for use in harsh environments, such as downhole applications. These include Li—S cells, molten salt electrolyte containing cells, combination lithium and other metal alloy anodes, and transition metal sulfides or other electroactive chalcogenides-containing materials as cathode active materials in addition to elemental sulfur, polysulfides, or sulfur-containing materials, such as sulfur-polymers.

### Li—S Cells

A suitable Li—S cell for meeting one or more of the challenges of harsh environments discussed above may include one or more of the following components:

an anode comprising lithium, stabilized Li/Si intermetallic or Li—Sn/Al alloy anode on nickel plated copper substrate;

a cathode comprising sulfur, polysulfide or sulfur polymer active material, or other electroactive chalcogenides-containing material;

a liquid, nonaqueaous, electrolyte comprising a solvent including organic high-boiling-point higher-glymes, that is glymes having a boiling point greater than 200° C., and a salt of any one or any combination of LiCl, LiF, LiBr, LiI, Li triflouromethane sulfonate, Li hexafluorophosphate, or Li imide. Preferably, the concentration of the one or more lithium salts is less than 0.15M; and

a separator comprising one or more metal oxides. The separator may also comprise a polymer matrix. Preferably the separator is flexible. The metal oxide may be selected from any one or any combination of AlO₂, SiO₂, high density SiO₂ glass material, pseudo-boehmite sol-gel separators, or other sol-gel, zerogel, aerogel or fumed based metal oxide separator chemistry. Examples of suitable pseudo-boehmite sol-gel coated separators include, but are not limited to, those described, in U.S. Pat. Nos. 6,410,182 and 6,423,444 to Carlson et al. the respective disclosures of which are incorporated herein by reference. Further examples of other coated separator include, but are not limited to, those described in U.S. Pat. Nos. 5,882,721 and 5,948,464 to Delnick, and U.S. Pat. No. 6,148,503 to Delnick et al. Sol-gel and other coated separators offer the advantage of being directly coatable onto the cathode or anode surface. The polymer matrix is selected to provide flexibility and provide stability in the harsh environments.

In alternative embodiments, the electrolyte may be a molten salt electrolyte, and further comprise one or more electrolyte salts.

The Li/S cells and batteries may be primary or rechargeable (secondary) cells.

In some embodiments, cells according to the invention attain a utilization of 50-75% over 2-10 cycles. In others the utilization may be 10-75% over 200 cycles, or 38-75% over 2-50 cycles.

### Performance Characteristics

In the above described embodiments, at least one of the cathode assembly or its components, the anode assembly or its components, the separator or its components, the optional binder(s) for the cathode and/or the separator, the electrolyte, the electrolyte mixture or components of the electrolyte mixture, such as electrolyte additives or the solvent, are selected such that they can operate in electrochemical cells or batteries at 80-200° C., 90-200° C., 100-250° C., 125-200° C., 125-175° C., 135-200° C., 80-120° C., 90-120° C., 80-150° C., 90-150° C., greater than or equal to 100° C., greater than or equal to 80° C., greater than or equal to 90° C., greater than or equal to 125° C., greater than or equal to 130° C., greater than or equal to 135° C., or greater than or equal to 150° C.

Therefore, in some embodiments, electrochemical cells are adapted for use in harsh environments by increasing their operating lives in said environments. In some of these embodiments, the operating lives are increased by at least 500%, 400%, 300%, 200%, or 100%.

In these or other embodiments, electrochemical cells are adapted for use in harsh environments by increasing the cycle life of the cell while substantially maintaining sulfur utilization, and substantially maintaining discharge rates. In some cases, the cycle life is increased by more than 40%, more than 60%, or more than 80%.

The cells of the present invention deliver high capacity at ambient temperatures. In one embodiment, the cells of the present invention deliver, at a C/5 discharge rate, greater than 45% of the theoretical discharge capacity of the electroactive sulfur-containing material at 25° C. Some embodiments deliver 53% of the theoretical capacity of the electroactive sulfur-containing material at 25° C. at a C/2 rate, and some deliver 58% of the theoretical discharge capacity of the electroactive sulfur-containing material at 25° C. at a C/2 rate. The cells of the present invention deliver high capacity for many cycles at ambient temperature. For instance some cells deliver 46-48% of the theoretical discharge capacity of the electroactive sulfur-containing material at 25° C. at a 400 mA discharge current (higher than C/2) for cycles 6-60.

In some embodiments, the electrochemical cells demonstrate high cell utilizations over a large number of cycles while operating at high temperatures. For example, while operating at high temperatures cell utilizations of: 50-75% over 2-10 cycles; 10-75% over 200 cycles; 38-75% over 2-50 cycles; at least 65.85% after 20 cycles; at least 50.57% at the second cycle; at least 50.57% at the second cycle; at least 82.84% at the 12th cycle; at least 77.61% at the 18th cycle; at least 50.57% at the second cycle; at least 44.78% over 23 cycles; at least 44.78% over the 7th through 22nd cycles; at least 35.82% over 61 cycles; at least 31.34% over 65 cycles; at least 51.3% over 10 cycles; of 65.85% at the 2nd cycle; at least 57.07% after 30 cycles; 44.06% after 81 cycles; 22.7 to 26.9% after 76 cycles; 53.7% after 4 cycles; 52.5% after 2 cycles; and 38-75% over 2-50 cycles, are all within the scope of the invention.

Similarly, cells operating at high temperatures and exhibiting a utilization of the electroactive sulfur containing material of at least 35% over at least 200 cycles at a discharge rate of about 0.4 mA/cm² or a utilization of the electroactive sulfur containing material of at least 35% over at least 250 cycles at a discharge rate of about 0.4 mA/cm² are also within the scope of the invention.

In some embodiments, the electrochemical cells demonstrate high cell utilizations over a large number of cycles while operating at high temperatures. For example, while operating at high temperatures cells falling within the scope of the invention could have: an initial capacity of at least 1172 mAh/g and a utilization of at least 69.97%; a capacity of at least 1103 mAh/g and a utilization of at least 65.85% after 20 cycles; a capacity of at least 850 mAh/g and a utilization of at least 50.57% at the second cycle; a capacity of at least 850 mAh/g and a utilization of at least 50.57% at the second cycle; a capacity of at least 1387.5 mAh/g and a utilization of at least 82.84% at the 12th cycle; a capacity of at least 1300 mAh/g and a utilization of at least 77.61% at the 18th cycle; a capacity of at least 850 mAh/g and a utilization of at least 50.57% at the second cycle; a capacity of at least 750 mAh/g and a utilization of at least 44.78% over 23 cycles; a capacity of at least 1000 mAh/g and a utilization of at least 44.78% over the 7th through 22nd cycles; a capacity of at least 600 mAh/g and a utilization of at least 35.82% over 61 cycles; a capacity of at least 525 mAh/g and a utilization of at least 31.34% over 65 cycles; a capacity of at least 860 mAh/g and a utilization of at least 51.3% over 10 cycles; by a first cycle capacity of 1265 mAh/g and a utilization of 75.54%; a capacity of 1103 mAh/g and a utilization of 65.85% at the 2 cycle; a capacity of at least 956 mAh/g and a utilization of at least 57.07% after 30 cycles; an initial capacity of around 1382 mAh/g and a utilization of about 82.5%; a capacity of 738 mAh/g and a utilization of 44.06% after 81 cycles; an initial capacity of 1270 mAh/g and a utilization of 75.8%; a capacity of 380 to 450 mAh/g and a utilization of 22.7 to 26.9% after 76 cycles; a capacity of 900 mAh/g and a utilization of 53.7% after 4 cycles; or a capacity of 880 mAh/g and a utilization of 52.5% after 2 cycles.

In some embodiments, the cells deliver high discharge rates while maintaining a high discharge capacity. For example, cells according to the invention could deliver the following discharge rates: from C/5 to 5C and greater than 35% of the theoretical discharge capacity of the electroactive sulfur-containing material; after four discharge-charge cycles, delivering a discharge rate of C/5 and greater than 40% of the theoretical discharge capacity of the electroactive sulfur-containing material; after four discharge-charge cycles delivering at a C/5 rate greater than 35% of the theoretical discharge capacity of the electroactive sulfur-containing material; at each discharge cycle greater than 40% of the theoretical discharge capacity of the electroactive sulfur-containing material for more than 10 charge-discharge cycles at a C/5 rate; at each discharge cycle greater than 40% of the theoretical discharge capacity of the electroactive sulfur-containing material for more than 40 charge-discharge cycles at a C/5 rate; or 40% of the theoretical discharge capacity of the electroactive sulfur-containing material for more than 40 charge-discharge cycles at a C/5 rate when discharged to 0.0 V.

### EXAMPLES

Having now described preferred embodiments of the invention, alterations and modifications that do not depart from the spirit of the invention may occur to those skilled in the art. The invention is thus not limited to the preferred embodiments but is instead set forth in the appended claims and legal equivalents thereof. All patents, test procedures, and other documents cited in this specification are fully incorporated by reference to the extent that this material is consistent with this specification and for all jurisdictions in which such incorporation is permitted.

Moreover, some embodiments recite ranges. When this is done, it is meant to disclose each and every point within the range, including end points. For those embodiments that disclose a specific value or condition, other embodiments exist that are otherwise equivalent, but that exclude the value or the condition.

In the following Examples and Comparative Examples cells were prepared by the following method. The cathodes were prepared by coating a mixture of 70 parts by weight of elemental sulfur, 25 parts by weight of conductive carbon, and 5 parts by weight of a polyethylene powder, dispersed in isopropanol, onto a 12 micron thick conductive carbon coated aluminum film substrate. After drying, the coated cathode active layer thickness was about 30 microns. The anode was lithium foil of about 125 microns in thickness. The porous separator used was a 16-micron polyolefin separator. The above components were assembled in a layered structure of cathode/separator/anode, which was folded in half making a bicell, and placed in a foil pouch with liquid electrolyte (approximately 0.32 g). The bicell had an electrode area of about 33 cm². The sulfur content of the cell was 40 mg, equivalent to 67 mAH capacity (1675 mAH/g×0.04 g). After sealing the cell in a foil pouch, it was stored for 24 hours and then tested. Discharge-charge cycling of the cell was performed at 13.7 mA/7.8 mA, respectively, with discharge cutoff at a voltage of 1.5 V and charge cutoff at 2.4 V. The discharge rate of 13.7 mA is 0.42 mA/cm² for this cell (13.7 mA/33 cm²) and the charge rate of 7.8 mA is 0.24 mA/cm² (7.8 mA/33 cm²). The pause after each charge and discharge step was between 2 and 30 minutes. The temperature for the cell evaluation was performed at 20° C., 80° C. and 120° C. The following Examples and Comparative Examples describe the electrolytes and separators evaluated in these Li/S cells.

### Comparative Example 1

The electrolyte was a 0.5 m solution of lithium bis (trifluoromethylsulfonyl) imide, (lithium imide) and 0.17 m lithium nitrate in 1,3-dioxolane (DOL). The discharge capacity at the 4^{th} cycle was 45 mAH and specific capacity 1026 mAH/g. After the subsequent charge cycle (5^{th} charge cycle) the cell was allowed to rest for 24 hours at 80° C. before discharge (5^{th} discharge cycle). The discharge capacity at the 5^{th} cycle was 17 mAH and the specific capacity was 377 mAH/g of sulfur. Charge and discharge steps were resumed at 80° C. The discharge capacity at the 6^{th} cycle was 11 mAH and the specific capacity was 302 mAH/g of sulfur. Charge-discharge cycles were discontinued since the discharge capacity was below 18% utilization.

### Example 1

The electrolyte was that of Comparative Example 1 except that the solvent was tertaethylene glycol dimethyl ether (DMTeG). Cycling of the cell was performed by the procedure of Comparative Example 1. The 4^{th} cycle discharge capacity was 36 mA at 23° C. (871 mAH/g sulfur). Charge-discharge cycles were continued at 80° C. providing 39 mAH (957 mAH/g sulfur) until the discharge capacity diminished to 33 mAH (809 mAH/g of sulfur; 48% utilization), which was 16 cycles and the accumulated capacity 645 mAH.

### Example 2

The electrolyte was that of Comparative Example 2 except that lithium nitrate at a concentration of 0.4 m was incorporated in the 0.5 m electrolyte solution of lithium imide in DMTeG. Cycling of the cell was performed by the procedure of Comparative Example 1 except that the test temperature was 125° C. and that the discharge was stopped at 20 mAH (low depth of discharge, DOD). Charge-discharge cycles were continued until the discharge capacity diminished below 18 mAH (450 mAH/g of sulfur), which was 7 cycles and the accumulated capacity 138 mAH.

What is claimed is:

1. A rechargeable electrochemical cell comprising:
(a) an anode;
(b) a cathode comprising an electroactive chalcogenide-containing material; and
(c) a nonaqueous electrolyte;
wherein the cell is adapted for use in a high-temperature environment of greater than 80° C., and wherein the cell attains a utilization of 50-75% over 2-10 cycles.

2. The cell of claim 1 wherein the cell wherein the anode comprises lithium.

3. The cell of claim 2 wherein the anode comprises one or more of the group consisting of: stabilized Li/Si intermetallic, and Li—Sn/Al alloy anode on nickel-plated copper substrate.

4. The cell of claim 1 wherein the chalcogenide-containing material comprises a sulfur-containing material.

5. The cell of claim 2 wherein the cathode comprises sulfur, polysulfide or sulfur-polymer active material.

6. The cell of claim 4 wherein the cathode comprises sulfur, polysulfide or sulfur polymer active material.

7. The cell of claim 1 wherein the high-temperature environment is 90° C. or higher.

8. The cell of claim 1 wherein the high-temperature environment is 130° C. or higher.

9. The cell of claim 1 wherein the high-temperature environment is 150° C. or higher.

10. The cell of claim 1 that operates without mechanical cooling.

11. The cell of claim 1 wherein the nonaqueous electrolyte is a liquid.

12. The cell of claim 1 wherein the nonaqueous electrolyte comprises a solvent including organic high-boiling-point higher-glymes.

13. The cell of claim 1 wherein the nonaqueous electrolyte comprises a lithium salt

14. The cell of claim 12 wherein the nonaqueous electrolyte comprises a lithium salt.

15. The cell of claim 13 wherein the lithium salt is any one or any combination of LiCl, LiF, LiBr, LiI, Li triflouromethane sulfonate, lithium hexafluorophosphate, or lithium imide.

16. The cell of claim 14 wherein the lithium salt is any one or any combination of LiCl, LiF, LiBr, LiI, Li triflouromethane sulfonate, lithium hexafluorophosphate, or lithium imide.

17. The cell of claim 1 that attains a utilization of 50-75% over 2-10 cycles at temperatures between 80-120° C.

18. The cell of claim 1 that attains a utilization of 50-75% over 2-10 cycles at temperatures between 80-150° C.

19. The cell of claim 1 that attains a utilization of 50-75% over 2-10 cycles at temperatures between 80-200° C.

20. The cell of claim 1 further comprising a separator.

21. The electrochemical cell of claim 19 wherein the separator is flexible and comprises a one or more metal oxides and a polymer matrix.

22. The cell of claim 20 wherein the metal oxide is selected from of AlO₂, SiO₂, pseudo-boehmite sol-gel based coated separator or high density SiO₂ glass material.

23. A battery comprising a casing and at least one electrochemical cell of claim 1.

24. The battery of clam 23 wherein the casing is stainless steel.

25. The battery of claim 24 wherein the stainless steel case comprises at least one of a blowout valve or welded tabs.

26. A downhole monitoring devices comprising at least one electrochemical cell of claim 1.

27. The monitoring device of claim 26 where in the cell is recharged downhole.

28. A drilling system comprising at least one electrochemical cell of claim 1.

29. An electrochemical cell comprising:
(a) an anode comprising (i) stabilized Li/Si intermetallic, or (ii) Li—Sn/Al alloy anode on nickel-plated copper substrate;
(b) a cathode comprising sulfur, polysulfide or sulfur-polymer active material;
(c) a liquid electrolyte comprising a solvent including organic high-boiling-point higher-glymes and any one or any combination of LiCl, LiF, LiBr, LiI, Li triflouromethane sulfonate, Li hexafluorophosphate, or Li imide; and
(d) a separator comprising one or more metal oxides and a polymer matrix, wherein the metal oxide is selected from any one or any combination of AlO₂, SiO₂, pseudo-boehmite sol-gel based coated separator or high density SiO₂ glass material;
wherein the cell attains a utilization of 50-75% over 2-10 cycles.

30. The cell of claim 29 wherein the cell is used as a primary cell.

31. The cell of claim 29 where in the cell is a rechargeable cell.

32. The cell of claim 31 wherein the cell attains a utilization of 50-75% over 2-10 cycles at temperatures between 80-120° C.

33. The cell of claim 31 wherein the cell attains a utilization of 50-75% over 2-10 cycles at temperatures between 80-150° C.

34. The cell of claim 31 wherein the cell attains a utilization of 50-75% over 2-10 cycles at temperatures between 80-200° C.

35. The cell of claim 29 that operates without mechanical cooling.

36. A battery comprising a casing and at least one electrochemical cell of claim 29.

37. The battery of claim 36 wherein the casing is stainless steel case.

38. The battery of claim 37 wherein the stainless steel case comprises at least one of a blowout valve or welded tabs.

39. An electrochemical cell comprising;
(a) an anode comprising lithium;
(b) a cathode comprising an electroactive sulfur-containing material; and
(c) a non-aqueous electrolyte interposed between the anode and the cathode;
wherein, in the fully charged state of the cell, the cell delivers at a discharge rate of from C/5 to 5C, greater than 35% of the theoretical discharge capacity of the electroactive sulfur-containing material at temperatures of 80-200° C.

40. The cell of claim 39 wherein the cell is a primary cell.

41. The cell of claim 39 where in the cell is a rechargeable cell.

42. The cell of claim 39 wherein the cell delivers greater than 35% of the theoretical discharge capacity of the electroactive sulfur-containing material at temperatures of 90-150° C.

43. The cell of claim 39 wherein the non-aqueous electrolyte comprises one or more lithium salts.

44. The cell of claim 43, wherein the concentration of the one or more lithium salts is less than 0.1 M.

45. The cell of claim 39 that, after four discharge-charge cycles, delivers at a C/5 rate greater 40% of the theoretical discharge capacity of the electroactive sulfur-containing material.

46. The cell of claim 39 that, after four discharge-charge cycles, delivers at a C/5 rate greater than 35% of the theoretical discharge capacity of the electroactive sulfur-containing material.

47. The cell of claim 39 that delivers at each discharge cycle greater than 40% of the theoretical discharge capacity of the electroactive sulfur-containing material for more than 10 charge-discharge cycles.

48. The cell of claim 39 that delivers at each discharge cycle greater than 40% of the theoretical discharge capacity of the electroactive sulfur-containing material for more than 40 charge-discharge cycles at a C/5 rate.

49. The cell of claim 39, wherein the cell delivers 40% of the theoretical discharge capacity of the electroactive sulfur-containing material for more than 40 charge-discharge cycles at a C/5 rate when the cell is discharged to 0.0 V.

50. A battery comprising a casing and one or more cells of claim 39.
